(19) United States
(12) Patent Application Publication
(10) Pub. No.: US 2026/0358811 A1
(43) Pub. Date: Nov. 12, 2026

(54) MULTIPLE EXECUTION MODE PERCEPTION-TO-ACTION MODEL

(71) Applicant: QUALCOMM Incorporated, San Diego, CA (US)

(72) Inventors: Pietro Mazzaglia, Diemen (NL); Markus Peschl, Amsterdam (NL); Daniel Hendricus Franciscus Dijkman, Haarlem (NL)

(21) Appl. No.: 19/323,630

(22) Filed: Sep. 9, 2025

Related U.S. Application Data
(60) Provisional application No. 63/803,173, filed on May 9, 2025.

(51) Int. Cl. G05D 1/60; G05D 1/229; G05D 1/243

(52) U.S. Cl. CPC G05D 1/60; G05D 1/229; G05D 1/243

(57) ABSTRACT

An apparatus configured to perform perception-to-action (PTA) tasks includes a memory and processing circuitry in communication with the memory. The memory is configured to store sensor data of an environment and a language description of a task to be performed in the environment. The processing circuitry is configured to apply a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data. The processing circuitry is further configured to generate an output based on the task execution data.

This application claims the benefit of U.S. Provisional Application No. 63/803,173, filed May 9, 2025, the entirety of which is incorporated by reference herein.

### TECHNICAL FIELD

This disclosure relates to perception-to-action models.

### BACKGROUND

Perception-to-action (PTA) models can transform raw sensory inputs into meaningful, goal-directed actions by integrating perception, interpretation, and decision-making processes. PTA models may be applied in fields such as robotics, autonomous systems, and embodied artificial intelligence (AI), where an agent, such as a robotic arm, another type of robotic implement, or any other electronically-controlled device, may interact with its environment. One example of a PTA model is a Vision-Language-Action (VLA) model, which combines visual perception such as camera input, language understanding such as spoken or written commands, and action generation such as controlling a robotic arm, steering a car, navigating a smartphone app, or performing any other task that may be implemented by a device in a real, virtual, or hybrid (e.g., extended reality (XR)) environment. In a VLA model, visual and linguistic inputs may be encoded into feature representations, fused together to ground the language in a visual scene, and then passed through policy and/or control units that decide what physical action to execute.

### SUMMARY

In general, this disclosure describes techniques for implementing a PTA model, such as a VLA model, that can operate according to multiple execution modes. PTA models may be categorized as “non-thinking” and “thinking” models. Non-thinking models may perform actions based on the inputs without performing reasoning, or with minimal internal reasoning. These models may rely on supervised learning and mimic observed behavior from demonstrations. While fast and efficient, non-thinking models may fail at performing tasks correctly when faced with situations or instructions outside their training distribution. In contrast, thinking models incorporate mechanisms for reasoning, planning, and memory. Thinking models may use explicit representations, such as scene graphs or object-centric models, and may employ multi-step reasoning techniques, such as chain-of-thought prompting. Thinking PTA models may be better at adapting to new tasks and environments, but may use more computational resources.

Large datasets may be required to train a PTA model, including several demonstrations of tasks to be learned, in order to obtain high performance on the execution of those tasks. PTA models that perform thinking can perform better with smaller datasets. However, thinking PTA models tend to be slow at inference time, i.e., the time it takes to produce an action when applying the PTA model to new data. It can also be challenging to maintain data efficiency when training PTA models, e.g., using smaller datasets and still obtaining high performance.

In some examples, simple and/or highly repetitive tasks may benefit from non-thinking PTA model behavior (e.g., short inference time) because these tasks may be relatively easy for a PTA model to master or may be highly trained due to repetition. On the other hand, complex and/or low repetition tasks may benefit from thinking PTA model behavior (e.g., step-by-step reasoning) because these tasks may be difficult to master, or the PTA model may have little to no training on these tasks due to low repetition.

Computational resources can also play a role in determining whether a thinking or non-thinking PTA model will be more beneficial for a PTA implementation. For example, it may be desirable to deploy a PTA model on an edge-device that may have less computational resources than, e.g., a cloud computing system. In this case, the implementation of a thinking PTA model may not be a practical use of limited computational resources and/or may negatively affect some aspects of system performance, such as speed and power efficiency. However, the implementation of a non-thinking PTA model might not be the best option for all use cases because some aspects of system performance, such as correctness of task execution, can be negatively affected by the lack of thinking PTA model behavior.

This disclosure describes devices and techniques that leverage the benefits of thinking and non-thinking models in a multiple execution mode PTA model, such as a VLA model, that is configured to operate according to multiple execution modes including a thinking mode (e.g., a slow mode), wherein the PTA model performs reasoning (or additional reasoning beyond non-thinking behavior) to generate intentions before performing an action, and a non-thinking mode (e.g., a faster mode), wherein the PTA model performs actions without generating intentions. The techniques of this disclosure may allow a user, or the PTA model itself, to select between the thinking mode and the non-thinking mode. For example, the user may prompt the PTA model (e.g., using prepended or appended language to a prompt) to operate in the non-thinking mode to quickly execute tasks that can be implemented by a non-thinking PTA model without loss of performance. In another example, the user may prompt the PTA model to operate in the thinking mode to perform additional reasoning for tasks that may benefit from thinking PTA model behavior in spite of an increased inference time. The techniques of this disclosure may provide increased accuracy of task execution by implementing a PTA model with thinking capabilities while also improving computational efficiency and reducing inference time for certain tasks (e.g., simpler and/or highly repetitive tasks) by allowing the PTA model to be switched to non-thinking behavior when performing those tasks.

In an example, an apparatus configured to perform PTA tasks includes a memory and processing circuitry in communication with the memory. The memory is configured to store sensor data of an environment and a language description of a task to be performed in the environment. The processing circuitry is configured to apply a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data. The processing circuitry is further configured to generate an output based on the task execution data.

In another example, a method of performing PTA tasks includes: retrieving, by processing circuitry from memory, sensor data of an environment and a language description of a task to be performed in the environment; applying, by the processing circuitry, a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data; and generating, by the processing circuitry, an output based on the task execution data.

In another example, a non-transitory computer-readable storage medium has instructions encoded thereon, the instructions configured to cause processing circuitry to: retrieve, from memory, sensor data of an environment and a language description of a task to be performed in the environment; apply a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data; and generate an output based on the task execution data.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram of an example system that may perform PTA tasks by applying a PTA model that can operate according to multiple execution modes, in accordance with the techniques of this disclosure.

FIG. 2 is a block diagram illustrating an example configuration of the PTA model

FIG. 3 is a block diagram illustrating an example configuration of a computing system that may implement the PTA model.

FIG. 4 is a conceptual diagram illustrating example time durations of example tasks that may be implemented by a PTA model.

FIG. 5 is a conceptual diagram illustrating an example of applying a sample balancing technique to training data to rebalance the training data.

FIG. 6 is a flow diagram illustrating an example method of performing a PTA task by applying a PTA model that can operate according to multiple execution modes, in accordance with the techniques of this disclosure.

### DETAILED DESCRIPTION

A VLA model is a type of PTA model that combines visual perception, natural language understanding, and action generation within a unified framework. VLA models can process visual inputs, such as images or video frames, to identify objects, spatial relationships, and environmental features. VLA models can also interpret textual or spoken language inputs to extract task instructions, goals, or contextual cues. The integration of these two input modalities enables VLA models to generate contextually appropriate actions, either in a simulated environment or through a physical embodiment such as a robot.

VLA model architecture may employ separate visual and language encoders, often based on transformer networks, which convert raw inputs into dense embeddings. These embeddings can be fused through cross-attention mechanisms or other forms of joint representation learning. The resulting multimodal representation supports reasoning over both perceptual and linguistic information. Action outputs can be produced either through a policy network trained via reinforcement learning or through direct supervised mapping from multimodal embeddings to action sequences. Depending on the implementation, actions may be represented as low-level motor controls or high-level semantic steps within a task planner.

Training of VLA models may be conducted in interactive environments where an agent (e.g., a robot or an avatar) receives feedback based on task performance. Data used for training may include paired visual scenes, language instructions, and ground-truth action sequences. Evaluation may focus on task completion accuracy, generalization to novel instructions or environments, and robustness to perceptual ambiguity. VLA models represent a step toward embodied intelligence capable of performing complex tasks through integrated perception and language-guided decision-making.

A variety of neural network types may be used to implement a VLA model, or any other type of PTA model. For example, convolutional neural networks (CNNs) may be used for initial visual (or other sensor data) processing due to their efficiency and effectiveness in capturing local spatial features. Transformers have also become common across both vision and language modalities, providing powerful tools for modeling long-range dependencies and cross-modal interactions. For example, vision transformers (ViTs) represent images as sequences and use self-attention to understand spatial context. Text transformers can also be used to provide rich semantic embeddings for language instructions.

Recurrent neural networks (RNNs) can also be used, e.g., to model temporal sequences, such as predicting sequences of actions. Reinforcement learning-based models also rely on neural architectures like multi-layer perceptrons (MLPs) and RNNs, trained to optimize behavior over time through reward feedback. Such networks may be used to enable adaptive and autonomous decision-making in dynamic environments.

As previously discussed herein, PTA models, such as VLA models, may be categorized as “non-thinking” and “thinking” models. Non-thinking models may perform actions based on inputs without performing reasoning, or with minimal internal reasoning. These models may rely on supervised learning and mimic observed behavior from demonstrations. While non-thinking models are fast and efficient, non-thinking models may fail at performing tasks correctly when faced with situations or instructions outside their training distribution. In contrast, thinking models incorporate mechanisms for reasoning, planning, and memory. Thinking models may use explicit representations such as scene graphs or object-centric models, and thinking models may employ multi-step reasoning techniques such as chain-of-thought prompting. For example, “thinking” may refer to the process of integrating visual perception and language understanding with contextual reasoning to produce a coherent and goal-directed sequence of actions. This involves interpreting ambiguous or incomplete instructions, disambiguating references based on environmental cues, resolving conflicts between possible actions, and predicting the consequences of different behaviors before execution. Rather than relying solely on direct mappings from input to output, a thinking model maintains internal representations of goals, constraints, and environmental dynamics, allowing for planning, hypothesis testing, and decision-making under uncertainty. In general, thinking models may be better at adapting to new tasks and environments, but thinking models may require more computational resources.

Large datasets may be required to train PTA models, including several demonstrations of tasks to be learned, in order to obtain high performance on the execution of those tasks. PTA models that perform thinking can perform better with smaller datasets. However, thinking PTA models tend to be slower than non-thinking PTA models at inference. Inference refers to the stage where the trained system is applied to new, unseen data to produce actionable outputs without further learning or parameter updates. For example, during inference, a PTA model may take in sensor data, such as an image or video feed, and a language command, like “pick up item X and move it to location Y,” and may process these inputs to generate an appropriate action.

Unlike the training phase, where the model continually adjusts its weights to minimize error or maximize reward, inference is a fixed-weight, forward-pass computation where the system applies what it has already learned. This distinction can be important because inference efficiency directly impacts how well a PTA model performs in real-time or near-real-time environments, such as robotics. High inference latency, e.g., due to slow or computationally heavy predictions, can make a robot sluggish or unresponsive, which is especially problematic in tasks requiring precise timing or adaptive interactions with dynamic environments.

Simple and/or highly repetitive tasks may benefit from non-thinking PTA model behavior (e.g., short inference time) because these tasks may be easy for a PTA model to master or may be highly trained due to repetition. On the other hand, complex and/or low repetition tasks may benefit from thinking PTA model behavior (e.g., step-by-step reasoning) because these tasks may be difficult to master, or the PTA model may have little to no training on these tasks due to low repetition.

Computational resources can also play a role in determining whether a thinking or non-thinking PTA model will be more beneficial for a PTA implementation. For example, it may be desirable to deploy a PTA model on an edge-device that may have less computational resources than, e.g., a cloud computing system. In the context of PTA models, an edge device may refer to a computational unit located close to the physical environment where perception and action occur, rather than relying on centralized cloud infrastructure. Examples include mobile robots, drones, smart phones, or embedded systems in industrial settings. These devices are equipped with onboard sensors and limited processing capabilities, enabling real-time execution of PTA models without the latency and bandwidth constraints associated with remote data transmission. Deploying PTA models on edge devices may require careful optimization of model size, memory usage, and inference speed to ensure responsiveness and energy efficiency in dynamic, resource-constrained environments. Accordingly, the implementation of a thinking PTA model on an edge device may not be a practical use of limited computational resources and/or may negatively affect some aspects of system performance such as speed and power efficiency. However, the implementation of a non-thinking PTA model might not be the best option either because some aspects of system performance, such as correctness of task execution, can be negatively affected by the lack of thinking PTA model behavior.

This disclosure describes devices and techniques that leverage the benefits of thinking and non-thinking model behaviors in a multiple execution mode PTA model that is configured to operate according to multiple execution modes including a thinking mode, wherein the PTA model performs reasoning (or additional reasoning beyond non-thinking behavior) to generate intentions before performing an action, and non-thinking mode, wherein the PTA model performs actions without generating intentions. In some examples, the techniques of this disclosure may further allow users to view and/or edit intentions generated by the PTA model in order to correct or modify an aspect of task performance.

The techniques of this disclosure may allow a user, or the PTA model itself, to select between the thinking mode and the non-thinking mode. For example, the user may prompt the PTA model to operate in the non-thinking mode to quickly execute tasks that can be implemented by a non-thinking PTA model without loss of performance. In another example, the user may prompt the PTA model to operate in the thinking mode to perform additional reasoning for tasks that may benefit from thinking PTA model behavior in spite of an increased inference time. The techniques of this disclosure may provide increased accuracy of task execution by implementing a PTA model with thinking capabilities while also improving computational efficiency and reducing inference time for certain tasks (e.g., simpler and/or highly repetitive tasks) by allowing the PTA model to be switched to non-thinking behavior when performing those tasks. Although some of the examples described in this disclosure are related to VLA models, the techniques of this disclosure may also be applied to other types of PTA models such as, but not limited to, advanced driving assistance systems and event-driven control systems.

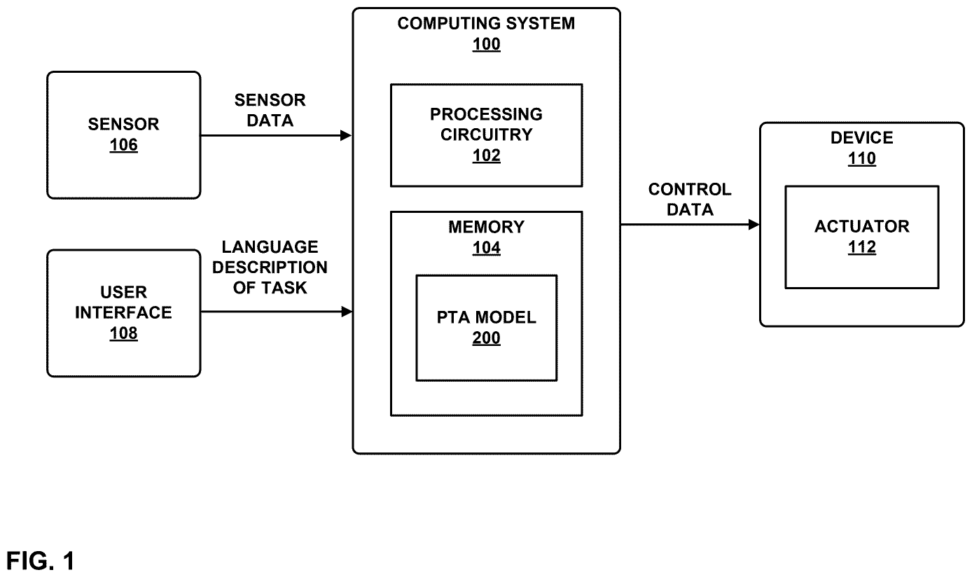

FIG. 1 is a block diagram of an example system that may perform PTA tasks by applying a PTA model 200 that can operate according to multiple execution modes, in accordance with the techniques of this disclosure. In the example of FIG. 1, the system includes a computing system 100 in communication with at least one sensor 106, such as a camera or other imaging device. The computing system 100 may also be in communication with or may include a user interface 108, such as an input device (e.g., keyboard, touchpad, touchscreen, microphone, or the like) that can receive and/or process user inputs and/or an output device (e.g., a display, speaker, or the like) that can present or otherwise relay information to a user.

In the example of FIG. 1, the system also includes a device 110 that is configured to be controlled to perform PTA tasks, i.e., based on inputs that are processed by PTA model 200. In some examples, device 110 is a robot or robotic component (e.g., robotic arm or steering wheel) that includes at least one actuator 112, such as an electric motor. In other examples, device 110 may be a virtual component, such as an avatar, virtual assistant, or simulated robot or robotic component that is configured to perform tasks in a virtual environment, an XR environment, or within an app or browser.

As further described below, computing system 100 may include processing circuitry 102 and memory 104 that perform the techniques of this disclosure. For example, processing circuitry 102 may be configured to execute program instructions from memory 104 that cause processing circuitry 102 to perform any of the functions described herein. Memory 104 may also store information such as sensor data, user inputs, and PTA model 200 or at least a portion thereof. Computing system 100 may be separate from device 110, or alternatively, device 110 may include computing system 100 or at least a portion thereof.

In some examples, processing circuitry 102 is configured to collect, via sensor 106, sensor data of an environment. For example, the sensor data may comprise image data, such as one or more images or a video recording, of the environment that are captured by sensor 106 (e.g., a camera, screen capture device, or any other type of imaging device). Processing circuitry 102 may be further configured to store the sensor data in memory 104. In other examples, the sensor data may be transmitted to computing system 100 by another device, such as a smartphone or any other computing system, or downloaded/uploaded to memory 104, e.g., from an external storage device. As used herein, “sensor data” is not limited to information collected by a physical sensor. In some examples, sensor data may include images, visual inputs, and/or other data of an environment that are generated by a virtual sensor, e.g., a screen capture device, image generator, virtual mapping system, or the like.

In some examples, processing circuitry 102 may be configured to receive, via user interface 108, a language description of a task to be performed in the environment. For example, a user may provide a user input, via user interface 108, that includes the language description of the task to be performed in the environment. Processing circuitry 102 may be further configured to store the language description of the task in memory 104. In other examples, the language description of the task to be performed in the environment may be transmitted to computing system 100 by another device, such as a smartphone or any other computing system, or downloaded/uploaded to memory 104, e.g., from an external storage device.

As described in further detail below, processing circuitry 102 may be configured to apply PTA model 200 to the sensor data and the language description of the task to be performed in the environment based on an execution mode that is selected from a set of selectable execution modes including, but not limited to: a thinking mode, wherein the PTA model 200 is configured to generate intention data and task execution data; and a non-thinking mode, wherein the PTA model 200 is configured to generate the task execution data without the intention data. Processing circuitry 102 is further configured to generate an output based on the task execution data. For example, the output may comprise control data that causes device 110 to perform the task in the environment.

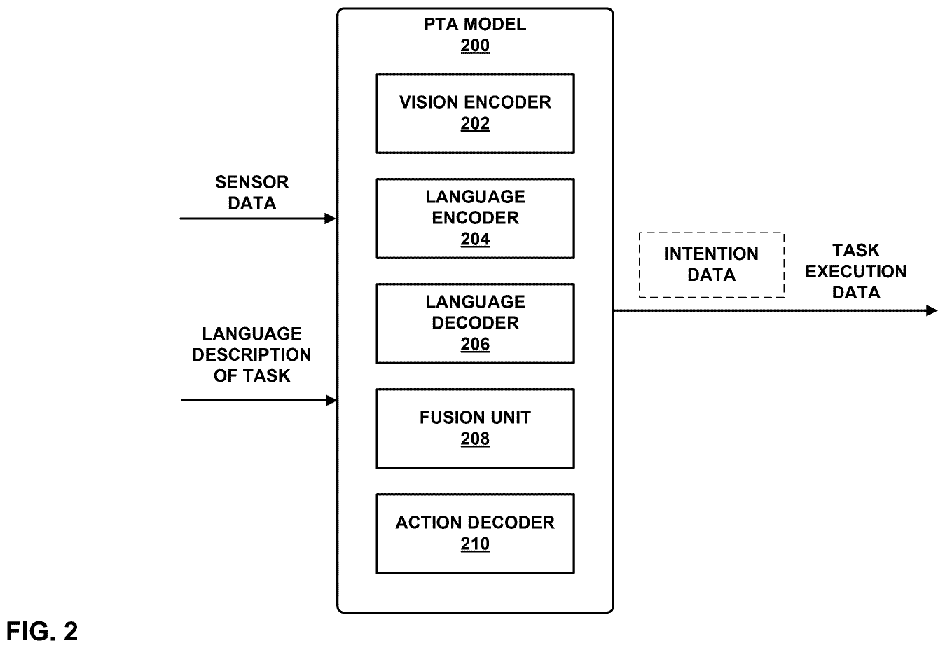

FIG. 2 is a block diagram illustrating an example configuration of PTA model 200. PTA model 200 may be implemented by a multi-component architecture designed to process and integrate information from different modalities. In the example of FIG. 2, PTA model 200 (e.g., a VLA model) includes a vision encoder 202, a language encoder 204, a language decoder 206, a fusion unit 208, and an action decoder 210. In some examples, PTA model 200 is a thinking model, wherein the thinking behavior can be selectively disabled based on the execution mode (e.g., thinking mode or non-thinking mode) of PTA model 200.

Vision encoder 202 processes the sensor data or other visual input data depicting an environment, such as an image or video frame. In some examples, vision encoder 202 may be implemented by a CNN that can extract spatial features from the sensor data. CNNs are known for their ability to capture hierarchical patterns through convolutional layers, making them suitable for object detection and localization. In other examples, vision encoder 202 may be implemented by a ViT that can segment an image into patches and apply self-attention mechanisms to capture complex spatial dependencies across the entire image.

Language encoder 204 processes the language description of the task to be performed in the environment. For example, language encoder 204 may process natural language input, such as task description (e.g., “pick up object X”) entered by a user via user interface 108. Language encoder 204 may be configured to operate on the language description in parallel (or at least partially in parallel) with the processing of sensor data by vision encoder 202. Language encoder 204 may be implemented by a transformer-based model such as large language models (LLM) that can convert language instructions into contextualized embeddings that capture the semantics of the command, including objects, actions, and spatial relationships.

When PTA model 200 operates in a thinking mode, language decoder 206 generates intention data by transforming fused multimodal embeddings into structured outputs that represent actionable goals. This process involves parsing semantic content from encoded language, aligning this parsed meaning with corresponding visual features, and producing an intermediate representation that specifies target objects, spatial attributes, and required operations. Instead of natural language tokens, language decoder 206 may emits either discrete action symbols or continuous intention vectors, which serve as input to policy networks or planners. Language decoder 206 may also incorporate temporal ordering so that complex tasks are represented as sequences of intentions, such as movement, grasping, and placement. This structured intention data forms the critical link between high-level linguistic commands and low-level control signals, ensuring that abstract instructions are grounded in perceptual context and expressed in a form usable by PTA model 200.

Fusion unit 208 integrates the visual and linguistic information from the sensor data and language description, respectively. For example, fusion unit 208 may combine the outputs of vision encoder 202 and language encoder 204 into a unified representation. Some fusion methods involve concatenating the visual and text embeddings followed by a projection through an MLP. However, more sophisticated approaches use cross-modal transformers that can leverage cross-attention mechanisms allowing for the language representation to attend to relevant visual features and vice versa. Additionally, some fusion architectures learn joint embedding spaces where visual and textual data are projected into a shared space, enabling more coherent multimodal reasoning.

Action decoder 210 translates the unified representation output by fusion unit 208 into an actionable output, referred to herein as “task execution data.” Action decoder 210 may be implemented by an MLP or a transformer that generates a sequence of high-level instructions, e.g., to perform tasks involving discrete actions, such as navigating or manipulating objects. For continuous control tasks, such as in robotics, action decoder 210 may produce joint angles or end-effector positions. In more advanced settings, reinforcement learning (RL) is used to train policy networks that map inputs to optimal outputs. Algorithms like Proximal Policy Optimization (PPO) or Soft Actor-Critic (SAC) may be employed to train these networks through trial and error, enabling the PTA model 200 to learn from its interactions with the environment. In some examples, task execution data may include instructions that cause processing circuitry or a device to perform the task. For example, task execution data may comprise control data or may form the basis for control data that can be used to control a device, such as device 110 of FIG. 1.

PTA model 200 may be configured to operate in multiple execution modes including at least the following: (1) a thinking mode (e.g., a slow mode), wherein the PTA model 200 is configured to generate intention data and task execution data; and (2) a non-thinking mode (e.g., a fast mode), wherein the PTA model 200 is configured to generate the task execution data without the intention data. Intention data may describe an inferred goal or desired outcome that guides the model's decision-making process in response to a given language instruction and visual or other environmental context. For example, the intention data may represent a high-level semantic target derived from interpreting the task directive, such as navigating to a location, manipulating a specific object, or performing a series of actions. The intention data serves as an intermediate representation that links language understanding with action generation, allowing the model to plan and execute behavior that aligns with the inferred objective while adapting to the observed environment. In some examples, the intention data may include observations (e.g., “item X is on the floor”), reasoning (e.g., “object Z in front of item X; object Z must be avoided to reach item X”), and/or planned sequences of actions (e.g., “pick up item X; move item X to location Y”).

In an example where the language description of the action to be performed is “pick up item X and move it to location Y,” PTA model 200 may generate intention data that includes, e.g., “item X is on the floor; location Y is on the table; move to location Y; pick up item X; place item X on the table.” In this example, the intention data exhibits erroneous reasoning by the model because item X must be picked up before it is moved to location Y otherwise the table will block device 110 (e.g., a robotic arm) from being able to pick up item X to place it on the table. In some examples, PTA model 200 may be configured to output the intention data and allow for editing of the intention data by a user or another entity. For example, PTA model 200 may be configured to provide an option to edit the intention data in a sub-mode of the thinking mode and/or via an edit feature of the thinking mode. In other examples, PTA model 200 may allow for editing the intention data in an editable thinking mode, i.e., another execution mode of the set of selectable execution modes, wherein PTA model 200 is configured to generate the intention data and the task execution data, and wherein the PTA model 200 is further configured to provide the option to edit the intention data.

As described below, PTA model 200 may be implemented by machine learning system that includes a mode selection unit in communication with or integrated within PTA model 200. The mode selection unit may enable PTA model 200 to be switched between different execution modes (e.g., thinking and non-thinking modes) based on user inputs (e.g., based on a user input prompt to operate in a thinking mode or a non-thinking mode), or in some examples, automatically based on a confidence level generated by the model itself.

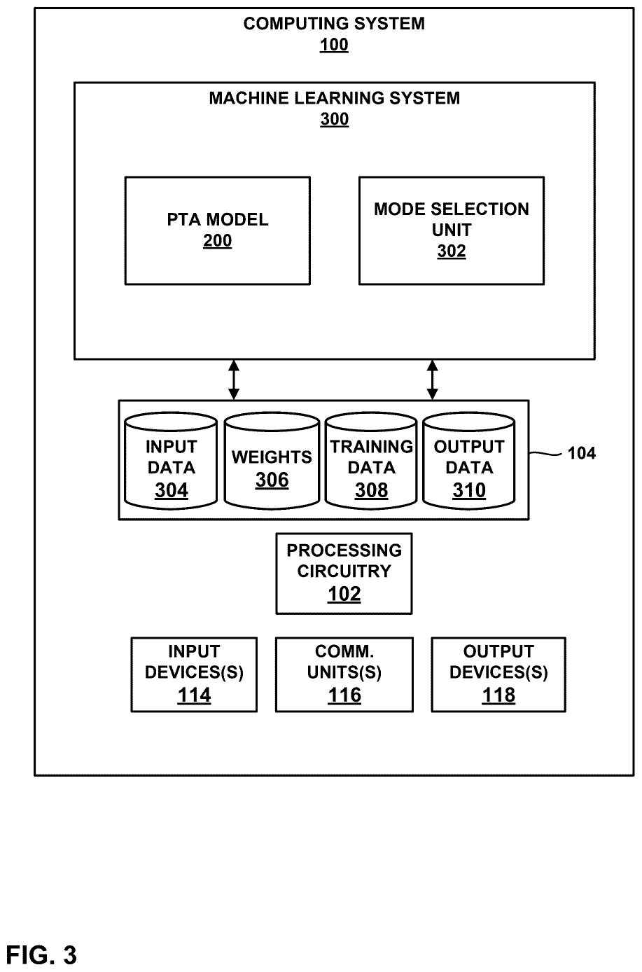

FIG. 3 is a block diagram illustrating an example configuration of computing system 100. Computing system 100 includes processing circuitry 102 and memory 104 for executing a machine learning system 300, which may represent an example instance of any machine learning system described in this disclosure, such as PTA model 200. Machine learning system 300 may include one or more neural networks that implement PTA model 200, such as, but not limited to, RNNs, CNNs, and deep neural networks (DNNs), as described in greater detail below.

Computing system 100 may be implemented as an embedded computing system (e.g., built into device 110), one or more desktop computers, workstations, laptops, mobile devices (e.g., smartphone or tablets), mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 100 may represent a cloud computing system, server farm, and/or server cluster (or portion thereof) that provides services to client devices and other devices or systems. In other examples, computing system 100 may represent or be implemented through one or more virtualized compute instances (e.g., virtual machines, containers, etc.) of a data center, cloud computing system, server farm, and/or server cluster.

The techniques described in this disclosure may be implemented, at least in part, in hardware, software, firmware or any combination thereof. For example, various aspects of the described techniques may be implemented within processing circuitry 102 of computing system 100, which may include one or more of a microprocessor, a controller, a DSP, an ASIC, an FPGA, or equivalent discrete or integrated logic circuitry, or other types of processing circuitry. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

In another example, computing system 100 comprises any suitable computing system having one or more computing devices, such as desktop computers, laptop computers, gaming consoles, smart televisions, handheld devices, tablets, mobile telephones, smartphones, etc. In some examples, at least a portion of computing system 100 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Memory 104 may comprise one or more storage devices. One or more components of computing system 100 (e.g., processing circuitry 102, memory 104) may be interconnected to enable inter-component communications (physically, communicatively, and/or operatively). In some examples, such connectivity may be provided by a system bus, a network connection, an inter-process communication data structure, local area network, wide area network, or any other method for communicating data. Processing circuitry 102 of computing system 100 may implement functionality and/or execute instructions associated with computing system 100. Examples of processing circuitry 102 include microprocessors, application processors, display controllers, auxiliary processors, one or more sensor hubs, and any other hardware configured to function as a processor, a processing unit, or a processing device. Computing system 100 may use processing circuitry 102 to perform operations in accordance with one or more aspects of the present disclosure using software, hardware, firmware, or a mixture of hardware, software, and firmware residing in and/or executing at computing system 100. The one or more storage devices of memory 104 may be distributed among multiple devices.

Memory 104 may store information for processing during operation of computing system 100. In some examples, memory 104 comprises temporary memories, meaning that a primary purpose of the one or more storage devices of memory 104 is not long-term storage. Memory 104 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Memory 104, in some examples, may also include one or more computer-readable storage media. Memory 104 may be configured to store larger amounts of information than volatile memory. Memory 104 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 104 may store program instructions and/or data associated with one or more of the modules described in accordance with one or more aspects of this disclosure.

Processing circuitry 102 and memory 104 may provide an operating environment or platform for one or more modules or units (e.g., PTA model 200), which may be implemented as software, but may in some examples include any combination of hardware, firmware, and software. Processing circuitry 102 may execute instructions and the one or more storage devices, e.g., memory 104, may store instructions and/or data of one or more modules. The combination of processing circuitry 102 and memory 104 may retrieve, store, and/or execute the instructions and/or data of one or more applications, modules, or software. The processing circuitry 102 and/or memory 104 may also be operably coupled to one or more other software and/or hardware components, including, but not limited to, one or more of the components illustrated in FIG. 3.

Processing circuitry 102 may execute machine learning system 300 using virtualization modules, such as a virtual machine or container executing on underlying hardware. One or more of such modules may execute as one or more services of an operating system or computing platform. Aspects of machine learning system 300 may execute as one or more executable programs at an application layer of a computing platform.

One or more input devices 114 of computing system 100 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine. In some examples, user interface 108 of FIG. 1 may include the one or more input devices 114.

One or more output devices 118 may generate, transmit, or process output. Examples of output are tactile, audio, visual, and/or video output. Output devices 118 may include a display, sound card, video graphics adapter card, speaker, presence-sensitive screen, one or more USB interfaces, video and/or audio output interfaces, or any other type of device capable of generating tactile, audio, video, or other output. Output devices 118 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 100 may include a presence-sensitive display that may serve as a user interface device that operates both as one or more input devices 114 and one or more output devices 118. In some examples, user interface 108 of FIG. 1 may include the one or more output devices 118.

One or more communication units 116 of computing system 100 may communicate with devices external to computing system 100 (or among separate computing devices of computing system 100) by transmitting and/or receiving data, and may operate, in some respects, as both an input device and an output device. In some examples, communication units 116 may communicate with other devices over a network. In other examples, communication units 116 may send and/or receive radio signals on a radio network such as a cellular radio network. Examples of communication units 116 include a network interface card (e.g., such as an Ethernet card), an optical transceiver, a radio frequency transceiver, a GPS receiver, or any other type of device that can send and/or receive information. Other examples of communication units 116 may include Bluetooth®, GPS, 3G, 4G, and Wi-Fi® radios found in mobile devices as well as Universal Serial Bus (USB) controllers and the like.

In the example of FIG. 3, PTA model 200 may receive input data 304 and may generate output data 310. In some examples, combination of data from one or more neural networks that make up PTA model 200 may be used as input data for a multilayer perception model. Input data 304 and output data 310 may contain various types of information. For example, input data 304 may include sensor data and a language description of the task to be performed in the environment. Output data 310 may include task execution data. When PTA model 200 is applied in the thinking mode, output data 310 may further include intention data. In some examples, machine learning system 300 includes a mode selection unit 302 that may be integrated into PTA model 200 or configured to control PTA model 200 by applying the model according to a selected execution mode. In some examples, PTA model 200 may include two different PTA models, e.g., a thinking model and a non-thinking model corresponding to the thinking and non-thinking modes, respectively. In such examples, mode selection unit 302 may apply the thinking model when the thinking mode is selected and the non-thinking model when the non-thinking mode is selected. In other examples, PTA model 200 is a hybrid model configured to perform thinking PTA model behavior and non-thinking PTA model behavior based on, e.g., weights 306 and/or training data 308 that are applicable to multiple execution modes of the hybrid model.

Each set of layers that make up PTA model 200 and/or other aspects of machine learning system 300 may include a respective set of artificial neurons. Layers for example, may include an input layer, a feature layer, an output layer, and one or more hidden layers. Layers may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer.

Each input of each artificial neuron in each layer of the sets of layers is associated with a corresponding weight in weights 306. Various activation functions are known in the art, such as Rectified Linear Unit (ReLU), TanH, Sigmoid, and so on.

Machine learning system 300 may comprise a pre-trained model that is trained using training data 308 and one or more pre-trained neural networks that make up PTA model 200, in accordance with techniques described herein. It should be noted that training data 308 may be shared by multiple computing devices and/or may be stored at the computing device that performs training of one or more models.

Computing system 100 is an example of a device and/or system that may perform the techniques of this disclosure. For example, processing circuitry 102 and memory 104 of computing system 100 may be configured to perform the functions described below to perform PTA tasks by applying PTA model 200 according to multiple execution modes, in accordance with the techniques of this disclosure.

Memory 104 may be configured to store input data 304 including sensor data of an environment and a language description of a task to be performed in the environment. In some examples, the sensor data may comprise image data, e.g., in implementations where PTA model 200 is a VLA model. In other examples, sensor data may include other types of sensor data such as temperature, force, inertial data, position data, or the like. In some examples, a user may provide a user input, via user interface 108, that includes the language description of the task to be performed in the environment. In other examples, the language description of the task to be performed in the environment may be transmitted to computing system 100 by another device, such as a smartphone or any other computing system.

Processing circuitry 102 may be configured to retrieve, from memory 104, the sensor data of the environment and the language description of the task to be performed in the environment. Processing circuitry 102 may be further configured to apply PTA model 200 to the sensor data and the language description of the task to be performed in the environment based on an execution mode that is selected from a set of selectable execution modes. The selectable execution modes may include, but are not limited to: (1) a thinking mode, wherein PTA model 200 is configured to generate intention data and task execution data; and (2) a non-thinking mode, wherein PTA model 200 is configured to generate the task execution data without the intention data. In some examples, the selectable execution modes may further include an editable thinking mode, as discussed below.

In some examples, processing circuitry 102 is configured to receive a user input to select the execution mode from the set of selectable execution modes. For example, a user may select the execution mode, e.g., by providing a user input via user interface 108 (which may include one or more input devices 114). In an example, a user may append or prepend a prompt that indicates a selected execution mode to a user entered language description of a task to be performed in the environment. For example, the user input entered via user interface 108 may include the following: “Place item X to the right of item Y. <think>” In this example, the prompt “<think>” may indicate that the selected execution mode is the thinking mode. Accordingly, processing circuitry 102 may apply PTA model 200 in the thinking mode, wherein PTA model 200 is configured to generate output data 310 comprising intention data and task execution data. In another example, the user input entered via user interface 108 may include the following: “Place item X to the right of item Y. <act>” In this example, the prompt “<act>” may indicate that the selected execution mode is the non-thinking mode. Accordingly, processing circuitry 102 may apply PTA model 200 in the non-thinking mode, wherein PTA model 200 is configured to generate output data 310 comprising task execution data without intention data. In other examples, the user input to select the execution mode can be in the form of a cursor selection, e.g., selecting a “thinking” check box or radio button to put PTA model 200 into the thinking mode or making a selection from a drop-down menu. In general, any form of user input may be used.

Processing circuitry 102 may be configured to apply the user input via mode selection unit 302. For example, based on the user input, mode selection unit 302 may select a thinking model or non-thinking model from multiple models that make up PTA model 200. In other examples, where PTA model 200 is a hybrid model, mode selection unit 302 may selectively enable or disable a thinking feature based on the selected execution mode.

In some examples, processing circuitry 102 (e.g., via mode selection unit 302) is configured to automatically select the execution mode from the set of selectable execution modes based upon the sensor data and the language description of the task to be performed in the environment. For example, processing circuitry 102 may be configured to determine a confidence level of processing the sensor data and the language description of the task to be performed in the environment with the PTA model 200.

Processing circuitry 102 may be further configured to select the execution mode from the set of selectable execution modes based on the confidence level. For example, when the confidence level is above a threshold confidence level, processing circuitry 102 may apply PTA model 200 in the non-thinking mode to process the sensor data and the language description of the task to be performed in the environment. And when the confidence level is below the threshold confidence level, processing circuitry 102 may apply PTA model 200 in the thinking mode to process the sensor data and the language description of the task to be performed in the environment.

In some examples, processing circuitry 102 may compare new inputs (i.e., current sensor data and language description of the task to be performed in the environment) against previously stored input data 304 to assess the similarity of the new inputs to the previously stored input data 304. Processing circuitry 102 may determine a higher confidence level of processing the new inputs that are similar to previously stored inputs and conversely a lower confidence level of processing the new inputs that are dissimilar to previously stored inputs.

Additionally or alternatively, processing circuitry 102 may be configured to assess a complexity of the sensor data and the language description of the task to be performed in the environment. In some examples, processing circuitry 102 may determine a confidence level that is inversely related to the complexity of the inputs. For example, processing circuitry 102 may determine a higher confidence level of processing lower complexity inputs and, conversely, a lower confidence level of processing higher complexity inputs.

When PTA model 200 is applied in the thinking mode, processing circuitry 102 may be configured to output the intention data via user interface 108 (e.g., via one or more output devices 118) before the task execution data is generated, afterwards, or concurrently (e.g., at least partially in parallel with generating the task execution data). In other examples, processing circuitry 102 may be configured transmit the intention data to another device via the one or more communication units 116.

Processing circuitry 102 may be further configured to receive (e.g., via user interface 108 or the one or more communication units 116) a user input to edit the intention data in order to generate edited intention data. Processing circuitry 102 may be further configured to modify the task execution data based on the edited intention data. For example, processing circuitry 102 may reapply PTA model 200 based on the edited intention data to generate modified task execution data. Alternatively, processing circuitry 102 may modify the task execution data by applying the edited intention data before PTA model 200 generates the task execution data.

In some examples, when the PTA model 200 is applied in the thinking mode, processing circuitry 102 may be configured to provide (e.g., via user interface 108) an option to edit the intention data. For example, processing circuitry 102 may provide the option to edit the intention data before the task execution data has been generated by PTA model 200, in which case, processing circuitry 102 may be configured to modify the task execution data by applying the edited intention data before PTA model 200 generates the task execution data. Alternatively, in other examples, processing circuitry 102 may provide the option to edit the intention data after the task execution data has been generated by PTA model 200, or at least partially in parallel with generating the task execution data by PTA model 200. In such examples, processing circuitry 102 may be configured to modify the task execution data by reapplying PTA model 200 based on the edited intention data to generate modified task execution data.

As discussed above, in an example where the language description of the action to be performed is “pick up item X and move it to location Y,” PTA model 200 may generate intention data that includes, e.g., “item X is on the floor; location Y is on the table; move to location Y; pick up item X; place item X on the table.” In this example, the intention data exhibits erroneous reasoning by the model because item X must be picked up before it is moved to location Y otherwise the table will block device 110 (e.g., a robotic arm) from being able to pick up item X to place it on the table. Processing circuitry 102 may be configured to edit the intention data based on a user input, e.g., to generate edited intention data such as “item X is on the floor; location Y is on the table; pick up item X; move to location Y; place item X on the table.”

In the thinking mode, PTA model 200 may provide an option/ability to edit intention data without any additional step to enable editing, regardless of whether the user actually makes edits or not. Alternatively, PTA model 200 may be configured to provide an option to edit the intention data in a sub-mode of the thinking mode and/or via an edit feature of the thinking mode. In other examples, PTA model 200 may allow for editing the intention data in an editable thinking mode, i.e., another execution mode of the set of selectable execution modes, wherein PTA model 200 is configured to generate the intention data and the task execution data and is further configured to provide the option to edit the intention data. For example, processing circuitry 102 may receive a user input entered via user interface 108 that includes the following: “<think and edit>place item X to the right of item Y.” In this example, the prompt “<think and edit>” may indicate that the selected execution mode is the thinking mode in an editable sub-mode or with an edit feature enabled, or that the selected execution mode is the editable thinking mode. Accordingly, processing circuitry 102 may apply PTA model 200 in the thinking mode with editing enabled, or alternatively in an editable thinking mode, wherein PTA model 200 is configured to generate output data 310 comprising intention data and task execution data and is further configured to provide an option to edit the intention data. In other examples, the user input to enable editing or to select the editable thinking mode can be in the form of a cursor selection, e.g., selecting an “edit” feature or “editable thinking” mode check box or radio button or making a selection from a drop-down menu. In general, any form of user input may be used to enable editing or to apply PTA model 200 in the editable thinking mode.

Processing circuitry 102 may be further configured to generate an output based on the task execution data. For example, the output based on the task execution data comprises control data that causes a device (e.g., device 110 of FIG. 1) to perform the task in the environment. In the example of FIG. 1, device 110 may be a robot or robotic component (e.g., robotic arm or steering wheel) that includes at least one actuator 112, such as an electric motor. Accordingly, the control data may include one or more control signals that cause actuator 112 to perform the task in the environment. Alternatively, the control data may include instructions that are executable by processing circuitry 102 or other processing circuitry of device 110 to control actuator 112 to perform the task in the environment. In other examples, device 110 may be a virtual component, such as an avatar, virtual assistant, or simulated robot or robotic component that is configured to perform tasks in a virtual environment, an XR environment, or within an app or browser. In such examples, the control data may include instructions that are executable by processing circuitry 102 or other processing circuitry of device 110 to perform the task in the environment.

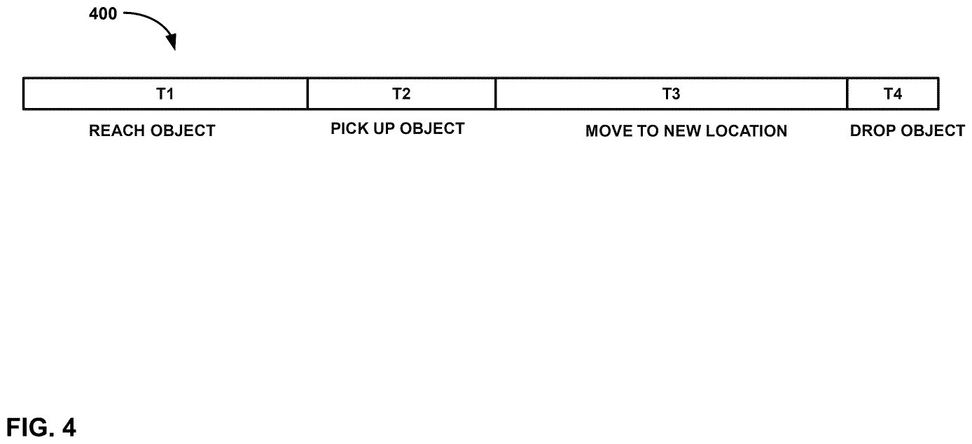

In examples, PTA model 200 is trained on training data 308 including examples of sensor data and examples of tasks to be performed in environments corresponding to the examples of sensor data. The time durations of different tasks or sub-tasks may differ quite a bit, particularly in the thinking mode, where inference time is generally higher. For example, FIG. 4 includes time plot 400 illustrating example time durations of example sub-tasks that may be implemented by PTA model 200 to perform a task of moving an object from one location to a different location. In the example of FIG. 4, certain tasks such as reaching for objects and moving to new locations may have longer execution and/or inference times (e.g., T1 and T3, respectively) than tasks such as picking up objects and dropping objects that have relatively shorter times (e.g., T2 and T4, respectively).

In general, different actions, and accompanying thoughts (i.e., intention data), in the dataset have different time durations. As a result, some PTA models, such as VLA models, may learn better and faster some actions and thoughts rather than others. For example, some models may learn “reaching” and “moving” actions better and faster than “picking” and “dropping” actions because the longer time duration (e.g., “reaching” and “moving”) actions may have higher representation in training data than shorter time duration actions.

According to techniques of this disclosure, training data 308 may be rebalanced, using a balancing factor β, to account for different time durations of tasks in training data 308 and/or different time durations of sub-tasks that make up the tasks in training data 308. For example, processing circuitry 102 may apply a thinking balanced sampling technique, wherein processing circuitry 102 may assess a current probability of sampling different actions in the dataset making up training data 308, based on their time duration. Processing circuitry 102 may then reassign the probabilities to offer a more balanced sampling, which may include a new balanced sampling distribution ρ_{new} that interpolates between an old sampling distribution ρ_{old} and a uniform distribution ρ_{uniform}, which may be optimal for machine learning. In some examples, processing circuitry 102 may apply the balancing factor β as follows to generate the new balanced sampling distribution ρ_{new:}

ρ_{new}=ρ_{old}+β+(1−β)*ρ_{uniform.}

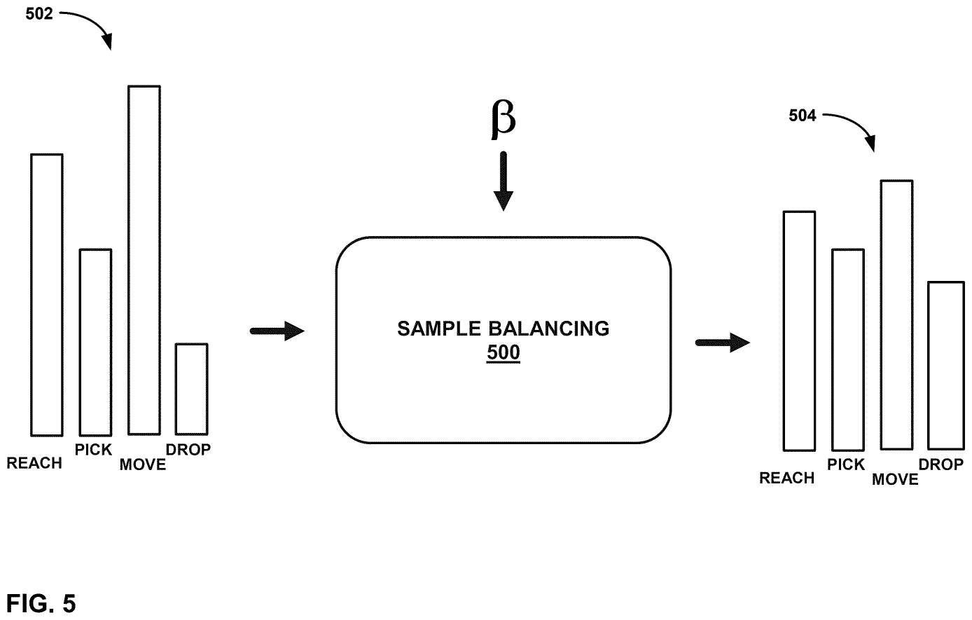

FIG. 5 conceptually illustrates an example of applying sample balancing 500, as described above, to a training data set 502 to generate a rebalanced training data set 504. In the example of FIG. 5, tasks have a more uniform distribution after sample balancing 500 is applied. Accordingly, PTA model 200 can be trained on the rebalanced training data set 504 to improve training on tasks that would otherwise be underrepresented, such as “picking” and “dropping” tasks in the example of FIG. 5.

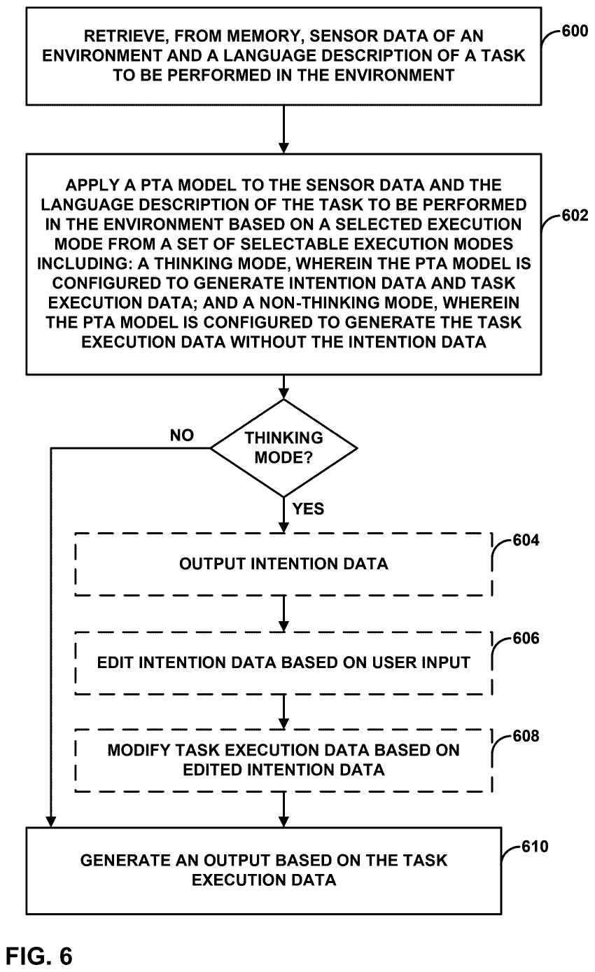

FIG. 6 is a flow diagram illustrating an example method of performing a PTA task by applying a PTA model that can operate according to multiple execution modes, in accordance with the techniques of this disclosure. Although described with respect to computing system 100 (FIGS. 1 and 3), it should be understood that other devices may be configured to perform a method similar to that of FIG. 6.

In the example of FIG. 6, processing circuitry 102 retrieves, from memory 104, the sensor data of the environment and the language description of the task to be performed in the environment (600). In some examples, the sensor data may comprise image data, e.g., in implementations where PTA model 200 is a VLA model. In other examples, sensor data may include other types of sensor data such as temperature, force, inertial data, position data, or the like. In some examples, a user may provide a user input, via user interface 108, that includes the language description of the task to be performed in the environment. In other examples, the language description of the task to be performed in the environment may be transmitted to computing system 100 by another device, such as a smartphone or any other computing system.

Processing circuitry 102 the applies PTA model 200 to the sensor data and the language description of the task to be performed in the environment based on an execution mode that is selected from a set of selectable execution modes (602). In some examples, the selectable execution modes may include, but are not limited to: (1) a thinking mode, wherein PTA model 200 is configured to generate intention data and task execution data; and (2) a non-thinking mode, wherein PTA model 200 is configured to generate the task execution data without the intention data. As previously discussed herein, in some examples, the selectable execution modes may further include an editable thinking mode.

In some examples, processing circuitry 102 may receive a user input to select the execution mode from the set of selectable execution modes. For example, a user may select the execution mode, e.g., by providing a user input via user interface 108 (which may include one or more input devices 114). Alternatively or additionally, processing circuitry 102 may automatically select the execution mode from the set of selectable execution modes based upon the sensor data and the language description of the task to be performed in the environment. For example, processing circuitry 102 may determine a confidence level of processing the sensor data and the language description of the task to be performed in the environment with the PTA model 200, and processing circuitry 102 may then select the execution mode from the set of selectable execution modes based on the confidence level.

When PTA model 200 is applied in the thinking mode, processing circuitry 102 may output the intention data (604). For example, processing circuitry 102 may output the intention data via user interface 108 (e.g., via one or more output devices 118) before the task execution data is generated, afterwards, or concurrently (e.g., at least partially in parallel with generating the task execution data). In other examples, processing circuitry 102 may be configured transmit the intention data to another device via the one or more communication units 116. Processing circuitry 102 may also receive (e.g., via user interface 108 or the one or more communication units 116) a user input to edit the intention data in order to generate edited intention data (606). Processing circuitry 102 may also modify the task execution data based on the edited intention data (608). For example, processing circuitry 102 may reapply PTA model 200 based on the edited intention data to generate modified task execution data. Alternatively, processing circuitry 102 may modify the task execution data by applying the edited intention data before PTA model 200 generates the task execution data.

In some examples, when the PTA model 200 is applied in the thinking mode, processing circuitry 102 may provide (e.g., via user interface 108) an option to edit the intention data. For example, processing circuitry 102 may provide the option to edit the intention data before the task execution data has been generated by PTA model 200, in which case, processing circuitry 102 may be configured to modify the task execution data by applying the edited intention data before PTA model 200 generates the task execution data. Alternatively, in other examples, processing circuitry 102 may provide the option to edit the intention data after the task execution data has been generated by PTA model 200, or at least partially in parallel with generating the task execution data by PTA model 200. In such examples, processing circuitry 102 may modify the task execution data by reapplying PTA model 200 based on the edited intention data to generate modified task execution data.

In some examples, PTA model 200 may provide an option to edit the intention data in a sub-mode of the thinking mode and/or via an edit feature of the thinking mode. In other examples, PTA model 200 may allow for editing the intention data in an editable thinking mode, i.e., another execution mode of the set of selectable execution modes, wherein PTA model 200 is configured to generate the intention data and the task execution data and is further configured to provide the option to edit the intention data. In other examples, in the thinking mode, PTA model 200 may provide an option to edit intention data without any additional step to enable editing, regardless of whether the user actually makes edits or not.

When PTA model 200 is not applied in the thinking mode, e.g., when PTA model 200 is applied in the non-thinking mode, processing circuitry 102 may skip blocks 604-608. Furthermore, when PTA model 200 is applied in the thinking mode, blocks 604-608 may be optional.

Processing circuitry 102 generates an output based on the task execution data (610). For example, the output based on the task execution data comprises control data that causes a device (e.g., device 110 of FIG. 1) to perform the task in the environment. In the example of FIG. 1, device 110 may be a robot or robotic component (e.g., robotic arm or steering wheel) that includes at least one actuator 112, such as an electric motor. Accordingly, the control data may include one or more control signals that cause actuator 112 to perform the task in the environment. Alternatively, the control data may include instructions that are executable by processing circuitry 102 or other processing circuitry of device 110 to control actuator 112 to perform the task in the environment. In other examples, device 110 may be a virtual component, such as an avatar, virtual assistant, or simulated robot or robotic component that is configured to perform tasks in a virtual environment, an XR environment, or within an app or browser. In such examples, the control data may include instructions that are executable by processing circuitry 102 or other processing circuitry of device 110 to perform the task in the environment.

The techniques of this disclosure may provide increased accuracy of task execution by implementing PTA model 200 with thinking capabilities while also improving computational efficiency and reducing inference time for certain tasks (e.g., simpler and/or highly repetitive tasks) by allowing PTA model 200 to be switched to non-thinking behavior when performing those tasks. In the non-thinking mode, PTA model 200 is capable of performing inference with low latency and low inference costs, allowing for PTA model 200 to be implemented on edge devices such as robotic and smartphone chips. Meanwhile, in the thinking mode, PTA model 200 improves data efficiency by supporting smaller sets of training data to achieve successful task performance.

In some examples, the techniques of this disclosure also allow for user-intervention to read and optionally edit intention data before task execution. Furthermore, as described above, the techniques of this disclosure may provide improved sampling distribution of training data by applying thinking balanced sampling technique, which allows PTA model 200 to be trained in a more data-efficient manner, by iterating over different thoughts (i.e., intention data) in the dataset, with a balanced and varied distribution.

Examples in the various aspects of this disclosure may be used individually or in any combination.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

The following numbered clauses illustrate one or more aspects of the devices and techniques described in this disclosure.

Clause 1. An apparatus configured to perform perception-to-action (PTA) tasks, the apparatus comprising: a memory configured to store sensor data of an environment and a language description of a task to be performed in the environment; and processing circuitry in communication with the memory, wherein the processing circuitry is configured to: apply a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data; and generate an output based on the task execution data.

Clause 2. The apparatus of clause 1, wherein the PTA model is a vision-language-action (VLA) model.

Clause 3. The apparatus of any of clauses 1 and 2, wherein the sensor data comprises image data.

Clause 4. The apparatus of any of clauses 1-3, wherein the output based on the task execution data comprises control data that causes a device to perform the task in the environment.

Clause 5. The apparatus of any of clauses 1-4, wherein the processing circuitry is further configured to output the intention data via a user interface.

Clause 6. The apparatus of clause 5, wherein the processing circuitry is further configured to: receive, via the user interface, a user input to edit the intention data to generate edited intention data; and modify the task execution data based on the edited intention data.

Clause 7. The apparatus of any of clauses 5 and 6, wherein the processing circuitry is further configured to provide, via the user interface, an option to edit the intention data based upon at least one of: a sub-mode of the thinking mode; an edit feature of the thinking mode; or another execution mode of the set of selectable execution modes comprising an editable thinking mode, wherein the PTA model is configured to generate the intention data and the task execution data and is further configured to provide the option to edit the intention data.

Clause 8. The apparatus of any of clauses 1-7, wherein the processing circuitry is configured to receive, via a user interface, a user input to select the execution mode from the set of selectable execution modes.

Clause 9. The apparatus of any of clauses 1-8, wherein the processing circuitry is configured to automatically select the execution mode from the set of selectable execution modes based upon the sensor data and the language description of the task to be performed in the environment.

Clause 10. The apparatus of clause 9, wherein to automatically select the execution mode from the set of selectable execution modes based upon the sensor data and the language description of the task to be performed in the environment, the processing circuitry is configured to: determine a confidence level of processing the sensor data and the language description of the task to be performed in the environment; and select the execution mode from the set of selectable execution modes based on the confidence level.

Clause 11. The apparatus of any of clauses 1-10, wherein the PTA model is trained on training data that has been rebalanced, using a balancing factor, to account for at least one of different time durations of tasks in the training data or different time durations of sub-tasks that make up the tasks in the training data.

Clause 12. A method of performing perception-to-action (PTA) tasks, the method comprising: retrieving, by processing circuitry from memory, sensor data of an environment and a language description of a task to be performed in the environment; applying, by the processing circuitry, a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data; and generating, by the processing circuitry, an output based on the task execution data.

Clause 13. The method of clause 12, wherein the PTA model is a vision-language-action (VLA) model.

Clause 14. The method of any of clauses 12 and 13, wherein the sensor data comprises image data.

Clause 15. The method of any of clauses 12-14, wherein the output based on the task execution data comprises control data that causes a device to perform the task in the environment.

Clause 16. The method of any of clauses 12-15, further comprising outputting, by the processing circuitry, the intention data via a user interface.

Clause 17. The method of clause 16, further comprising: receiving, by the processing circuitry via the user interface, a user input to edit the intention data to generate edited intention data; and modifying, by the processing circuitry, the task execution data based on the edited intention data.

Clause 18. The method of any of clauses 16 and 17, further comprising, providing, by the processing circuitry via the user interface, an option to edit the intention data based upon at least one of: a sub-mode of the thinking mode; an edit feature of the thinking mode; or another execution mode of the set of selectable execution modes comprising an editable thinking mode, wherein the PTA model is configured to generate the intention data and the task execution data and is further configured to provide the option to edit the intention data.

Clause 19. The method of any of clauses 12-18, further comprising receiving, by the processing circuitry via a user interface, a user input to select the execution mode from the set of selectable execution modes.

Clause 20. The method of any of clauses 12-19, further comprising automatically selecting, by the processing circuitry, the execution mode from the set of selectable execution modes based upon the sensor data and the language description of the task to be performed in the environment.

Clause 21. The method of clause 20, wherein automatically selecting, by the processing circuitry, the execution mode from the set of selectable execution modes based upon the sensor data and the language description of the task to be performed in the environment comprises: determining, by the processing circuitry, a confidence level of processing the sensor data and the language description of the task to be performed in the environment; and selecting, by the processing circuitry, the execution mode from the set of selectable execution modes based on the confidence level.

Clause 22. The method of any of clauses 12-21, wherein the PTA model is trained on training data that has been rebalanced, using a balancing factor, to account for at least one of different time durations of tasks in the training data or different time durations of sub-tasks that make up the tasks in the training data.

Clause 23. A non-transitory computer-readable storage medium having instructions encoded thereon, the instructions configured to cause processing circuitry to: retrieve, from memory, sensor data of an environment and a language description of a task to be performed in the environment; apply a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data; and generate an output based on the task execution data.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Where a phrase similar to “one or more processors configured to X, Y, and Z” or “processing circuitry configured to X, Y, and Z” is used in the claims, it is intended that the phrase be interpreted to mean at least: that a processor A alone may perform functions X, Y, and Z; that two or more processors (e.g., processors A and B) may collectively perform functions X, Y, and Z; that a first processor A may perform functions X and Y and a second processor may perform function Z; or that a first processor A may perform function X, a second processor may perform function Y, and a third processor may perform function Z.

Where a phrase similar to “at least one of A, B, and C” is used in the claims, it is intended that the phrase be interpreted to mean that A alone may be present in an embodiment; B alone may be present in an embodiment; C alone may be present in an embodiment; or that any combination of the elements A, B, and C may be present in a single embodiment, for example, A and B, A and C, B and C, or A and B and C.

Various examples have been described. These and other examples are within the scope of the following claims.

What is claimed is:

1. An apparatus configured to perform perception-to-action (PTA) tasks, the apparatus comprising:
a memory configured to store sensor data of an environment and a language description of a task to be performed in the environment; and
processing circuitry in communication with the memory, wherein the processing circuitry is configured to:
apply a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data; and
generate an output based on the task execution data.

2. The apparatus of claim 1, wherein the PTA model is a vision-language-action (VLA) model.

3. The apparatus of claim 1, wherein the sensor data comprises image data.

4. The apparatus of claim 1, wherein the output based on the task execution data comprises control data that causes a device to perform the task in the environment.

5. The apparatus of claim 1, wherein the processing circuitry is further configured to output the intention data via a user interface.

6. The apparatus of claim 5, wherein the processing circuitry is further configured to:
receive, via the user interface, a user input to edit the intention data to generate edited intention data; and
modify the task execution data based on the edited intention data.

7. The apparatus of claim 5, wherein the processing circuitry is further configured to provide, via the user interface, an option to edit the intention data based upon at least one of: a sub-mode of the thinking mode; an edit feature of the thinking mode; or another execution mode of the set of selectable execution modes comprising an editable thinking mode, wherein the PTA model is configured to generate the intention data and the task execution data and is further configured to provide the option to edit the intention data.

8. The apparatus of claim 1, wherein the processing circuitry is configured to receive, via a user interface, a user input to select the execution mode from the set of selectable execution modes.

9. The apparatus of claim 1, wherein the processing circuitry is configured to automatically select the execution mode from the set of selectable execution modes based upon the sensor data and the language description of the task to be performed in the environment.

10. The apparatus of claim 1, wherein to automatically select the execution mode from the set of selectable execution modes based upon the sensor data and the language description of the task to be performed in the environment, the processing circuitry is configured to:
determine a confidence level of processing the sensor data and the language description of the task to be performed in the environment; and
select the execution mode from the set of selectable execution modes based on the confidence level.

11. The apparatus of claim 1, wherein the PTA model is trained on training data that has been rebalanced, using a balancing factor, to account for at least one of different time durations of tasks in the training data or different time durations of sub-tasks that make up the tasks in the training data.

12. A method of performing perception-to-action (PTA) tasks, the method comprising:
retrieving, by processing circuitry from memory, sensor data of an environment and a language description of a task to be performed in the environment;
applying, by the processing circuitry, a PTA model to the sensor data and the language description of the task to be performed in the environment based on an execution mode that is selected from a set of selectable execution modes including: a thinking mode, wherein the PTA model is configured to generate intention data and task execution data;
and a non-thinking mode, wherein the PTA model is configured to generate the task execution data without the intention data; and
generating, by the processing circuitry, an output based on the task execution data.

13. The method of claim 12, wherein the PTA model is a vision-language-action (VLA) model.

14. The method of claim 12, wherein the sensor data comprises image data.

15. The method of claim 12, wherein the output based on the task execution data comprises control data that causes a device to perform the task in the environment.

16. The method of claim 12, further comprising outputting, by the processing circuitry, the intention data via a user interface.

17. The method of claim 16, further comprising:
receiving, by the processing circuitry via the user interface, a user input to edit the intention data to generate edited intention data; and
modifying, by the processing circuitry, the task execution data based on the edited intention data.

18. The method of claim 16, further comprising, providing, by the processing circuitry via the user interface, an option to edit the intention data based upon at least one of: a sub-mode of the thinking mode; an edit feature of the thinking mode; or another execution mode of the set of selectable execution modes comprising an editable thinking mode, wherein the PTA model is configured to generate the intention data and the task execution data and is further configured to provide the option to edit the intention data.

19. The method of claim 12, wherein the PTA model is trained on training data that has been rebalanced, using a balancing factor, to account for at least one of different time durations of tasks in the training data or different time durations of sub-tasks that make up the tasks in the training data.

20. A non-transitory computer-readable storage medium having instructions encoded thereon, the instructions configured to cause processing circuitry to:
retrieve, from memory, sensor data of an environment and a language description of a task to be performed in the environment;
apply a PTA model to the sensor data and the language description of the task to be performed in the environment based on an execution mode that is selected from a set of selectable execution modes including: a thinking mode, wherein the PTA model is configured to generate intention data and task execution data; and a non-thinking mode, wherein the PTA model is configured to generate the task execution data without the intention data; and
generate an output based on the task execution data.
